(19) United States
(12) Patent Application Publication
(10) Pub. No.: US 2009/0207074 A1
(43) Pub. Date: Aug. 20, 2009

(54) Near simultaneous dissemination of global data from many sources to many receivers

(76) Inventor: Aniruddha Das, King of Prussia, PA (US)

Correspondence Address: Dr. Aniruddha Das, 268 Larkspur Lane, King of Prussia, PA, 19406, US

(21) Appl. No.: 12/070,292

(22) Filed: Feb. 19, 2008

(51) Int. Cl. G01S 1/00

(52) U.S. Cl. 342/357.06

(57) ABSTRACT

An architecture for near simultaneous, truly global method of dissemination of tracking and logistical data from many sources to many receivers has been invented. The method has been exemplified through the use of the GPS constellation and three classes of military users, differentiated by their data transmission power levels. With a small increase of the GPS constellation size, addition of RF transceivers to the spot beam antennas, and the use of simultaneous CDMA, TDMA and frequency diversity, many tens of thousands of users can be serviced with very modest resource requirements for the user.

### CROSS REFERENCE TO RELATED APPLICATIONS (IF ANY)

Not applicable

### STATEMENT OF FEDERALLY SPONSORED RESEARCH/DEVELOPMENT (IF ANY)

Not applicable

### REFERENCE TO A “SEQUENCE LISTING”

Not applicable

### BACKGROUND OF THE INVENTION

There is a great need for disseminating many classes of data, such as position, velocity, logistics, etc., of many different sources to many different users of that data in a near simultaneous manner. In general, the users are also sources. The sources and users can be dispersed all over the globe. The desired data dissemination service is required to be secure, with assured delivery and with minuscule probability of being compromised.

This is a classic communication problem, which can be solved by expensive mobile communication platforms, which consume significant amounts of power, and are heavy. The sources of the data can be cooperative or non-cooperative. The required corresponding communications infrastructure will require many communication satellites covering the globe with secure links and assured delivery and display. The resulting system becomes so expensive that it is not economically feasible, and unsatisfactory like the Iridium system. The disclosed invention provides a solution to this problem for three classes of users. These three classes are differentiated by their available data transmission power, and are denoted as High Power User (HPU), Medium Power User (MPU) and Low Power User (LPU).

It should be noted that communication systems depending on geosynchronous space vehicles (SV) are not truly global. That is because geosynchronous SVs have an inclination of nearly zero degrees, and cannot communicate with users in the high latitudes near the poles of the earth.

### BRIEF SUMMARY OF THE INVENTION

The invention provides a communication architecture that solves the communication problem of providing near simultaneous dissemination of global data from many sources to three classes of many tens of thousands of users. All three classes in this exemplification are from the military and are differentiated by their RF power available for data transmission. Users with one Watt of transmission power are denoted as Low Power Users (LPU). Users with ten Watt of transmission power are denoted as Medium Power Users (MPU). Users without power limitations are denoted as High Power Users (HPU). The military users already have equipment to receive position data from the Global Position System (GPS). The United States Air Force (USAF) is planning to launch a new generation of GPS SVs, named GPS III, in a constellation of typically 30 SVs with secure communication links. The GPS III Block C SVs are expected to have spot-beam (SB) antenna and transmission capabilities. By increasing the number of SB equipped SVs in the GPS constellation to 36, i.e., with a small increase of six SVs in the GPS III Block C constellation, and with this newly invented communications architecture, the abovementioned three classes of users over the whole globe can be provided with the data that they want. In GPS SVs, spot-beams are to be used for transmission only. In the present architecture, some of those SB antennas will not transmit, but will be used for receiving data from the sources (by the addition of a transceiver), and thus establishing two-way communications between the sources and the SV constellation.

This invention is based on communication links through GPS or similar SVs, which are at much lower altitudes than those of geosynchronous satellites and are inclined by at least 50 degrees so as to be able to communicate with users over the whole earth, including the users who are near the poles.

### BRIEF DESCRIPTION OF THE SEVERAL VIEWS OF THE DRAWING (IF ANY)

Not applicable.

### DETAILED DESCRIPTION OF THE INVENTION

The invented communication architecture utilizes the spot-beam equipped GPS III Block C constellation augmented to 36 SVs equally spaced in the constellation in either three or six planes. With that constellation, at least five of those SVs, and the corresponding SB antennas, will be visible from all points on the earth.

GPS SVs normally transmit navigation messages in the Radio Frequencies (RF) in the L-Band at a high power. GPS III Block C SVs are planned to have an earth coverage (EC) transmission system in the L-Band, together with a regional coverage transmission system using spot beam (SB) antennas, also in the L-Band. A large number of military users are already equipped with receivers able to receive the L-Band transmissions from GPS SVs. In the invented architecture, those receivers in the possession of the users, will be modified to be able to transmit its own position, velocity and logistics data in the L-Band at a slightly different frequency, with a low power level, using secure cryptographic codes. Those receivers will also be able to find the direction and ranges to other cooperative and non-cooperative sources of interest and transmit those data in the L-Band as well. The class of users who use this L-Band link to communicate to the GPS constellation, with a transmission power level of the order of one Watt, are denoted as Low Power Users (LPU). The transmitted data collected from users all over the world become the basis of the data to be disseminated back to users all over he world.

An SV, which is transmitting navigation signals with its SB, will not most probably be able to receive any data from the LPU in L-Band due to self-jamming. In general four SVs with spot beams will be transmitting navigation data to an area of operation (AOO). However, due to the increased constellation size, there will be a fifth SB equipped SV in view of the AOO. In this architecture, al SB antennas in the GPS III Block C SVs will be connected to transceivers. That fifth SV in view of the AOO will not be transmitting with its SB, but use that SB antenna to listen to the low power transmissions in the L-Band from the user equipment with a low data rate, of the order of 50 bits per second (BPS). Analyses of that communication link show that the fidelity of the reception will be satisfactory with the bit error rate (BER) of the order of 1.0E-8. The fifth SV will use its inter satellite communication links (X-links) to send the received data to an SV in contact with a Master Control Center (MCC) on the earth. Ultimately all data received from all over the world will be sent to the MCC. That data will first be fused together at the MCC to eliminate duplicate and erroneous data, and then retransmitted back to the GPS constellation for dissemination to users all over the world.

All SVs typically have RF equipment to transmit onboard telemetry data to the MCC and to receive command and control data from the MCC. The GPS SVs are no exception and possess RF equipment to communicate to the MCC in higher frequency bands at a very high data rate. These are called the RF Gateways. The MCC has a large antenna to receive this data stream at a high rate. As mentioned before, there will be at least five SVs in view of the MCC, with only one SV communicating the command and control information to the MCC. The RF Gateways in the other SVs will be in a standby mode. In this architecture, the SVs, which have RF Gateways in the standby mode, will communicate massive amounts of tracking and logistics data to/from the second class of users, called the High Power Users (HPU). The HPU are not power limited, and will receive all the data collected from all over the world.

The third class of users will be called the medium power users (MPU) who can afford at least ten watts of power and have two tracking antennas, one pointed at the SV that is listening for user transmissions and the other antenna pointed at the SV which is transmitting tracking and logistics data through its RF Gateway. In this mode, link analyses indicate that the MPU can communicate with the SVs at a data rate of the order of 100 kilobits per second (KBPS) with a BER of the order of 1.0E-8.

In the invented architecture, the data to be transmitted to the LPU will be in the L-Band through the GPS navigation-messaging scheme, and be transmitted by the spot beams of the four SVs not listening to the users in the AOO. The communications to the MPU and the HPU will be at the higher data rates, in the higher frequency band of the RF Gateway.

In each frequency band, the number of users being serviced can be of the order of ten thousand or more. This will be achieved through the use of simultaneous code division multiple access (CDMA) using hundreds of orthogonal pseudo-random number (PRN) codes and time division multiple access (TDMA) techniques using hundreds of time slots per repeat cycle. Frequency diversity can be used to be able to service even higher number of users simultaneously. Typically, there will be an acquisition channel in an acquisition code, which stays on continuously. New users will access the system through the acquisition channel. After initial logging on, verification and authentication, the user will be assigned a particular time slot, code number and frequency. From then on, that user will use his assigned time, code and frequency parameters for communication with the system.

1. An architecture for near simultaneous, truly global method of dissemination of tracking and logistics data from many sources to many receivers has been invented.

2. The method has been exemplified through the use of the GPS constellation and three classes of military users, differentiated by their data transmission power levels.
